(19) United States
(12) Patent Application Publication
(10) Pub. No.: US 2013/0056544 A1
(43) Pub. Date: Mar. 7, 2013

(54) Low Noise Rail and Method of Manufacturing

(71) Applicant: Michael Karl Löffler, Jockgrim (DE)

(72) Inventor: Michael Karl Löffler, Jockgrim (DE)

(73) Assignee: 3M INNOVATIVE PROPERTIES COMPANY, ST. PAUL, MN (US)

(21) Appl. No.: 13/698,145

(22) PCT Filed: May 25, 2011
(86) PCT No.: PCT/US2011/037834

§ 371 Date: Nov. 15, 2012

(30) Foreign Application Priority Data
May 25, 2010 (EP) 10005411.3

(51) Int. Cl. E01B 19/00; B23P 11/00; E01B 5/02

(52) U.S. Cl. 238/150; 29/428

(57) ABSTRACT

There is provided a rail having a longitudinal direction defined by the rolling direction of a wheel of a rail vehicle along the rail, and a cross-sectional profile arranged normally to the longitudinal direction and having a vertical and a horizontal direction, the rail profile having a foot portion, a web portion and a head portion whereby the head portion has a lower head section fixedly connected to the web portion and an upper head section, the lower head section and the upper head section being separated from each other by a gap extending in the vertical and the horizontal direction, the gap comprising one or more elastomeric materials and the upper head section having a geometrical moment of inertia J in the vertical direction and an area A of the profile so that the product A×J^{1/3} is less than 230 cm^{10/3}.

### FIELD

The present disclosure relates to a rail comprising a foot portion, a web portion and a head portion whereby the head portion has a lower head section fixedly connected to the web portion and an upper head section which is not connected to the web portion or the lower head section. The upper head section and the lower head section are separated from each other by a gap comprising one or more elastomeric materials. The upper head section and the gap between the upper and the lower head section, respectively, being at least partly filled with an elastomer are designed so that the rolling noise created by a rail car rolling along said rail is reduced in comparison to a system comprising a conventional rail. The present disclosure furthermore relates to a method of manufacturing the low noise rail of the present disclosure.

### BACKGROUND

The environmental balance of railway transportation systems is generally considered as favorable because these systems can be operated essentially without any emission of CO₂ and because the space required to build railway transportation systems is lower than that needed for other mass transportation systems. On the other hand, the emission of noise which is increasingly negatively viewed by residents is an essentially unsolved problem of railway transportation systems.

The noise is based on various effects including, for example, aerodynamic noise, noise generated by motors and other traction aggregates and the rolling noise generated by the wheels of the engine and rail cars, respectively, travelling along the longitudinal direction of the railway track.

The rolling noise is the dominating noise source in the speed range of between 80 and 250 km/h. In the system comprising the railway wheel and the rail of the railway track the rolling noise is resulting from the dynamic forces between the mass of the wheel and the axis of a railway vehicle on the one hand and on the accoustically relevant mass of the rail on the other hand.

Attempts have been made to reduce the rolling noise of the wheel/rail system by attaching absorbing elements to the rail or varying the geometry of the rail, respectively.

In a first type of construction, conventional rail profiles have been resiliently embedded in the sleeper of railtracks and/or to support railway profiles by a resilient material.

DE 102 30 489, for example, discloses an elastically mounted rail comprising elastic intermediate layers which are arranged between the web and the foot of the rail and an outer frame in such a way that the rail does not contact the frame. The rail and the frame are arranged on a support plate resting on a base. At least one sliding element is arranged between the support plate and the base so that the support plate can slide relative to the base. The construction is useful, for example, on bridges to compensate for the difference in dilatation of the rail and the base, respectively. A reduction of the rolling noise is not mentioned.

In DE 44 15 892 the rail is fitted into a recess in the concrete sleeper with damping units being inserted between the web and the foot of the rail, respectively, and the concrete foundation. The damping units are of an entropy elastic material which is resistant to external factors such as temperature changes, ultra-violet light or moisture and comprises materials such as polyurethane, polyamide, ABS, polymerisate, silicone or a synthetic resin. The rail is reported to have favorable self-dampening and self-centering properties.

GB 468,182 discloses rails mounted in longitudinal channel-shaped sleepers which are made, for example, of reinforced concrete and which may be continuous or arranged in short lengths. The rail rests on a base of resilient plastic material, and the spaces between the web and the foot of the rail and the sleeper are also filled with a resilient plastic material. The plastic material may consist of rubber flour, coumarone resin and barium sulphate. The top of the resilient plastic material is covered with a layer of resilient plastic material resistant to oil and atmosphere. The resilient mounting of the rails is claimed to dampen the shocks and vibrations received by the trains and to also provide for an electric insulation of the rails. A noise reduction is not mentioned.

DE 38 34 329 relates to a rail bearing consisting of angular clamping plates, a rail support which is directly or indirectly screwed to the clamping plates, and an insulating element made of rubber or rubber-like material which is arranged between the foot and the web of the rail, the clamping plates and the rail support. An object addressed by DE '329 is the improvement of the dampening of the air-borne and the structure-borne noise, respectively.

GB 2,117,816 discloses a rail mounted to concrete sleepers by means of rigid and insulating collars cooperating with locking sleeper-screws. Resilient plates are arranged between the foot of the rail and the sleeper to provide for a dampening.

Additional structural means have been attached to the rail head to improve both the wear resistance and the noise dampening properties of the rail.

In WO 02/33,173 the additional structural means has a saddle-like profile shaped substantially in conformity with the shape of the rail head. The saddle-like means is located on top of the rail head and is mechanically de-coupled therefrom by resilient means interposed between the saddle-like additional structure and the rail head.

It is disclosed in GB 1,294,843 to place a strip of an elastomeric material onto the upper surface of the head of the rail profile on which the wheels of a railway vehicle are rolling, in order to provide non-frictional track brakes.

The geometry of the rail profile has been modified by including a dampening material into such profile.

U.S. Pat. No. 3,525,472 discloses a vibration-suppressing composite rail comprising a rail head and a lower part, cushion plates made of a material having a rubber-like elasticity and disposed on respective opposite sides of the rail and under the lower surfaces of the rail head, and a support structure clamping the cushion plates from both outer sides to provide an integral rail with the cushion plates interposed therebetween.

DE 33 19 182 provides disclosure about reducing the noise level during rail vehicle operation by arranging an insulating body between the rail foot and the rail head. The rail head may additionally be provided with a covering made of a plastic of high impact strength.

WO 03/012,203 provides a rail track arrangement in which a rail is removably supported in an inner shell, and the inner shell and rail are received within an outer shell which is supported by the concrete sleeper. Resilient damping layers may be included between both the rail and the inner shell and between the inner shell and the outer shell, respectively.

M. Hecht, M. Löffler and C. Gramowski, “Rollgeräuschreduktion durch innovative Schienkonstruktion” (Reduction of Rolling Noise by an Innovative Rail Construction), EI-Eisenbahningenieur, August 2008, pp. 6-10 disclose a modified S49 rail profile where part of the railway head was removed and then bonded to the base of the rail profile with a vulcanized elastomeric layer. The elastomer filled gap was linear and extended in parallel to the lower side of the rail foot and the foundation the rail was attached to. The railway track had a longitudinal extension of 11 m on which the rail vehicle was running straight ahead so that only vertical forces arose. A comparison of the rolling noise generated by a conventional S49 rail profile with the noise generated by the modified S49 profile showed a 10 dB lower noise level for the modified profile.

FR 2,890,988 discloses a rail profile comprising an interchangeable mushroom type rail head section mounted via an elastic bearing to the base of the profile. The profile is asymmetric and forms a cradle at the outer side of the profile facing away from the railway vehicle to safely receive the forces transmitted by the wheels of the railway vehicle. The inner side of the profile facing towards the railway vehicle comprises a groove for receiving one end of a C-shaped spring. The other end of the spring fits over a rib on the base of the rail profile so that the mushroom head is secured to the base. Rail profiles comprising interchangeable asymmetric mushroom type rail head sections mounted via an elastic bearing to the base of the profile are also disclosed in FR 2,814,477.

U.S. Pat. No. 319,041 discloses a rail profile comprising an enlarged head or cap section, a base section comprising a web section and a foot section, and an insulating material interposed between the head and the base section. The base section is essentially T-shaped, and the head is in the form of an inverted U. The insulating material which is of paper-maché or other suitable insulating material, is said to prevent concussion and wear of the rail and also to some extent the noise caused by the passage of the train.

Despite various attempts over a long period of time, the problem of reducing the rolling noise of the wheels of railway vehicles travelling along rails has not presently been solved. The reduction of the noise emitted from disclosed low-noise rail profiles in comparison to the corresponding, non-modified rail profiles are insufficient in practise and/or the low noise-profile was insufficiently mechanically stable and did not receive the stresses in both vertical and horizontal directions, at least not over a practically meaningful operation time. In other cases the low-noise profiles required methods of manufacturing which did not meet the practical requirements of a mass production process.

The present disclosure provides rail profiles which emit distinctly less noise than comparable conventional profiles and which do not exhibit the shortcomings of the disclosed low noise rail profiles or exhibit such shortcomings to a lower extent only, respectively. The present disclosure also provides for a favourable method of manufacturing low noise rail profiles that is easy to perform and/or meets the requirements of mass production.

Other aspects of the present disclosure can be taken from the detailed description.

### Short Description

The present disclosure relates to a rail having a longitudinal direction defined by the rolling direction of a wheel of a rail vehicle along the rail, and a cross-sectional profile arranged normally to the longitudinal direction and having a vertical and a horizontal direction, the rail profile having a foot portion, a web portion and a head portion whereby the head portion has a lower head section fixedly connected to the web portion and the upper head section, the upper and the lower head section being separated from each other by a gap extending in the vertical and the horizontal direction, the gap comprising one or more elastomeric materials and the upper head section having a geometrical moment of inertia J in the vertical direction and an area A of its profile so that the product A×J^{1/3} is less than 230 cm^{10/3}.

The present disclosure also relates to a rail having a longitudinal direction defined by the rolling direction of a wheel of a rail vehicle along the rail, and a cross-sectional profile arranged normally to the longitudinal direction and having a vertical and a horizontal direction, the rail profile having a foot portion, a web portion and a head portion whereby the head portion has a lower head section fixedly connected to the web portion and the upper head section, the lower and the upper head section being separated from each other by a gap extending in the vertical and the horizontal direction, the gap having at least a first gap section comprising one or more elastomeric materials and at least a second gap section having a width which is small enough so that the upper head section contacts the lower head section in the area of such second gap section when subjecting the rail to horizontal force components exerted by the rail vehicle.

The present disclosure also relates to a method of manufacturing a rail comprising the following steps.
(i) providing a lower portion of the rail comprising a foot portion, a web portion and a lower head section fixedly connected to the web portion,
(ii) providing an upper head section having a geometrical moment of inertia J in the vertical direction and an area A of its profile so that the product A×J^{1/3} is less than 230 cm^{10/3}, and
(iii) providing one or more elastomeric materials and arranging said one or more elastic materials intermediate between the upper and the lower head sections so that the upper and lower head sections are discontiguously separated from each other by a gap extending in the vertical and horizontal direction.

The present disclosure relates to a method of manufacturing a rail comprising the following steps.
(i) providing a lower portion of the rail comprising a foot portion, a web portion and a lower head section fixedly connected to the web portion,
(ii) providing an upper head section, and
(iii) providing one or more elastomeric materials and arranging said one or more elastic materials intermediate between the upper and the lower head sections so that the upper and lower head sections are discontiguously separated from each other by a gap extending in the vertical and the horizontal direction whereby the gap has at least a first gap section comprising said one or more elastomeric materials and at least a second gap section which is essentially free of said one or more elastomeric materials and has a width which is small enough so that the upper head section contacts the lower head section in the area of such second gap section when subjecting the rail to horizontal force components exerted by the rail vehicle.

### DESCRIPTION OF THE FIGURES

FIG. 1 is a schematic representation of a rail profile of the state of the prior art bearing the wheel rim of a railway vehicle running along such profile.

FIG. 2a is a schematic representation of a rail profile of the present disclosure.

FIG. 2b is a schematic representation of another rail profile of the present disclosure.

FIG. 2c is a schematic representation of another rail profile of the present disclosure.

FIG. 2d is a schematic representation of another rail profile of the present disclosure.

FIG. 3a is a schematic representation of another rail profile of the present disclosure.

FIG. 3b is a schematic representation of another rail profile of the present disclosure.

FIG. 3c is a schematic representation of another rail profile of the present disclosure.

FIG. 3d is a schematic representation of another rail profile of the present disclosure.

FIG. 4 is a schematic representation of another rail profile of the present disclosure.

FIG. 5a is a schematic representation of another rail profile of the present disclosure.

FIG. 5b is a schematic representation of an enlarged view of the vertical gap between the lower head section and the upper head section of the profile of FIG. 5a.

FIG. 6 is a schematic representation of another rail profile of the present disclosure.

FIG. 7a is a schematic representation of another rail profile of the present disclosure.

FIG. 7b is a schematic representation of another rail profile of the present disclosure.

FIG. 7c is a schematic representation of another rail profile of the present disclosure.

FIG. 7d is a schematic representation of another rail profile of the present disclosure.

FIG. 8a is a schematic side view of a railway track of the prior art.

FIG. 8b is a schematic side view of a railway track of the present disclosure.

FIG. 9 is a plot of the height of a rectangularly shaped upper head profile and of the E-module of the one or more elastomeric materials for different force regimes, respectively, as a function of the width of the profile.

FIG. 10 is a schematic representation of another rail profile of the present disclosure.

FIG. 11 is a schematic representation of another rail profile of the present disclosure.

FIG. 11a is a schematic representation of another rail profile of the present disclosure.

FIG. 12 is a schematic representation of another rail profile of the present disclosure.

FIG. 12a is a schematic representation of another rail profile of the present disclosure.

FIG. 13 is a schematic representation of another rail profile of the present disclosure.

### DETAILED DESCRIPTION

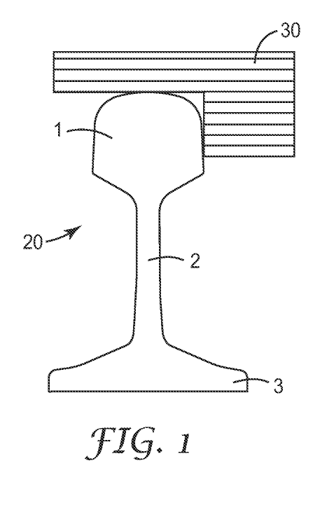

As used above and below the term rail profile denotes the cross-sectional shape of a railway rail (or simply rail) perpendicular to the longitudinal extension of the rail. Historically, there was a broad variety of rail profiles including, for example, bullhead rail profiles, grooved rail profiles, Vignol rail profiles, flanged trail profiles and bridge rail profiles (inverted U). Irrespective of the specific design, the rail profile has a top portion having an exposed surface on which the wheels of the railway vehicles travel along in a longitudinal direction; a bottom portion on which the profile rests and/or via which the profile is attached to the sleepers of the railway track; and an intermediate portion between said top portion and said bottom portion. The top portion is also referred to as rail head portion, the intermediate portion as rail web portion and the bottom portion as rail foot portion, respectively. A schematic profile of a Vignol type profile which is widely used today is attached as FIG. 1. The rail profile comprises a rail head portion 1 having an exposed surface on which the wheel of the railway vehicle travels along. The rail profile furthermore comprises a rail foot portion 3 on which the profile rests and/or through which it is attached to the sleepers. The rail head portion 1 and the rail foot portion 3 are connected by the rail web portion 2 which is often relatively thin in the horizontal direction. FIG. 1 is schematic only and does not restrict the present disclosure in any way.

The term railway rail or simply rail denotes a longitudinally extending railway profile along which the railway vehicles travel. Since railway rails are subject to very high stresses they usually are longitudinally extending hot rolled steel profiles made of high quality steel. The cross-sectional profile of the rails is the rail profile discussed above. Rails usually comprise rail sections of a standardized length which are usually connected via fusing or welding to rails of a larger length.

The term railway tracks (sometimes also referred to as rail tracks or railroad tracks) as used above and below denotes longitudinally extending surface structures that support and guide rail vehicles or other rail-guided transportation vehicles.

Railway tracks frequently comprise
two equidistant, longitudinally extending rails on which the wheels of the railway vehicles run;
a sequence of sleepers which are arranged normally to the direction of the longitudinal extension of rails and essentially equidistantly with respect to each other and, except for curves, essentially parallel to each other; and
a crushed stone ballast bed.

Below the ballast is a subgrade (formation) which may be the surface of the natural ground, or may have some geotechnical system installed to improve ground stability and drainage.

The present disclosure provides rail profiles which are arranged normally to the longitudinal direction and have a vertical and a horizontal direction. The longitudinal direction is defined as the direction into which the railway vehicle travels. The vertical and horizontal direction each are normal to the longitudinal direction; the vertical direction is the direction normal to the axis of the train and/or the sleeper of the railway track, respectively, and the horizontal direction is the direction normal to the vertical direction.

The profiles of the present disclosure have a foot portion, a web portion and a head portion whereby the head portion has a lower head section and an upper head section. The upper head section and the lower head section are separated from each other by a gap extending in the vertical and the horizontal direction.

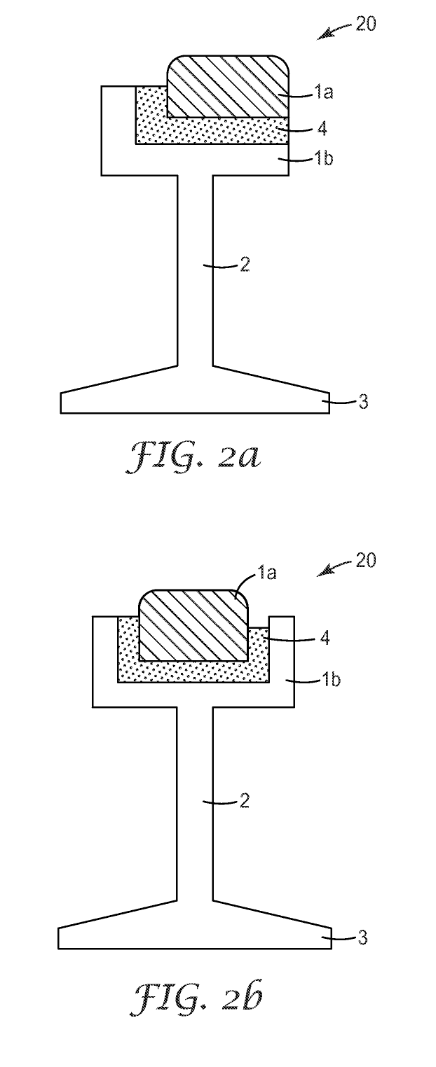

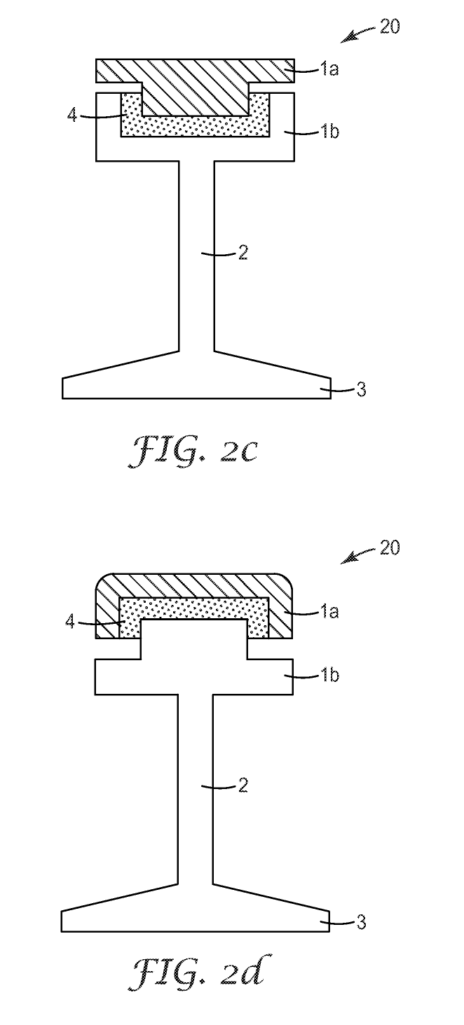

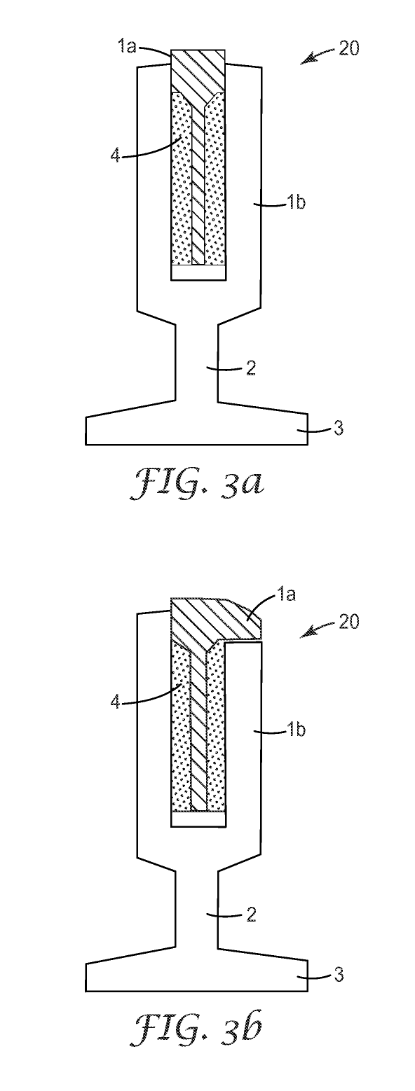

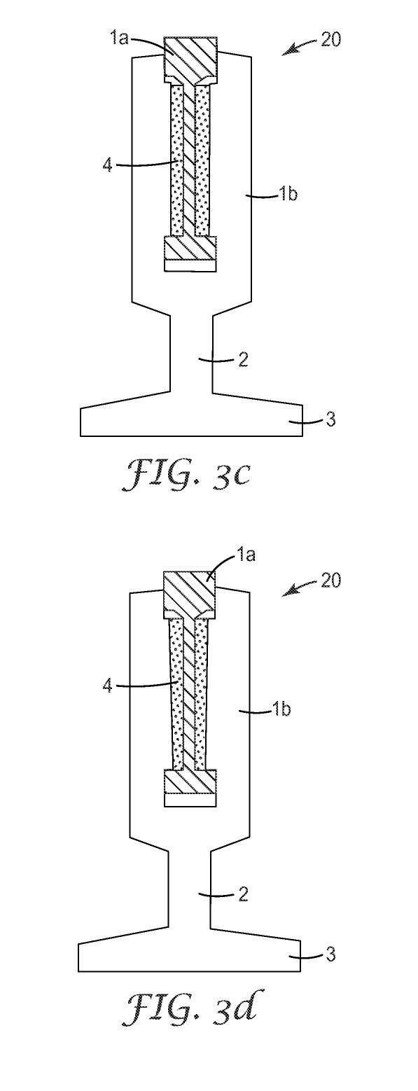

The length of the gap is the extension over which the upper and lower head sections are facing each other. The width of the gap, i.e. the distance between the lower and the upper head section, can be essentially constant throughout the extension of the gap as is shown, for example, in the embodiments of FIGS. 2a and 2b below. In other embodiments of the profiles of the present disclosure, the width of the gap can vary along the extension of the gap as is exemplified, for example, in FIG. 3a. In the embodiment of FIG. 3a the upper head section 1a has a so-called “sword configuration” so that the gap between the upper and the lower head sections 1a,1b is relatively large in the lower section of the sword, i.e. in the area of the “blade”. The vertically extending sections of the gap in the blade area are essentially completely filled with one or more elastomeric materials 4 whereas the bottom section of the gap in the blade area which extends horizontally does not comprise an elastomeric material and, if desirable, may provide for a safety clearance. In the upper section of the sword, i.e. in its “handle bar” the upper head section 1a is separated from the lower head section 1b only by a relatively small gap. This gap section is wide enough to allow for a movement of the handle bar in the vertical direction in response to a normal force acting on the upper head section 1a but small enough to allow for a contact between the handle bar and the lower head section 1b in response to forces action on the upper head section 1a which comprise a horizontal component. Such gap section which has a narrow width and allows for an accommodation of horizontal forces, may be filled with a lubricant such as graphite or a relatively ductile metal such as copper so that the upper head section's 1a sliding relative to the lower head section 1b in response to a normal force is facilitated.

In one embodiment the sections of the gap which are filled with one or more elastomeric materials 4 have a width of at least 10 mm. The term “filled” as used above and below preferably denotes that the respective gap section is completely filled with one or more elastomeric materials.

In some embodiments of the present disclosure the gap has at least a first gap section comprising one or more elastomeric materials and at least a second gap section having a width which is small enough so that the upper head section contacts the lower head section in the area of such second gap section when subjecting the rail to horizontal force components s exerted by the rail vehicle. The second section of the gap preferably has a width of less than 0.25 mm and more preferably of between 0.05 and 0.2 mm. The second section of the gap may preferably be filled with one or more lubricants and/or one or more ductile metals such as, for example, copper. The second section of the gap is preferably free of any elastomeric polymer material.

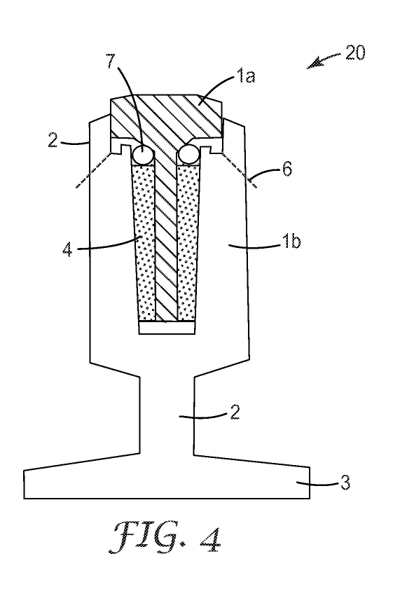

If desired a metal wire or cord may be included in the profile to provide an electrical contact between the upper and the lower head sections. This is exemplarily illustrated, for example, in FIG. 4.

The width of the gap preferably varies along the extension of the gap between 0.02 mm and 25 mm and more preferably between 0.05 mm and 20 mm. In sections of the gap which are filled with one or more elastomeric polymer materials the width of the gap preferably is between 5 and 25 mm, more preferably between 7 and 20 mm and especially preferably between 8 and 15 mm. In sections of the gap which preferably are not filled with an elastomeric polymer material and which are designed to allow for a contact between the upper head section 1a and the lower head section 1b when subjecting the upper head section to a force comprising a horizontal component, the width of the gap preferably is between 0.03 and 1 mm and more preferably between 0.05 and 0.2 mm.

In the profile of the present disclosure at least part of the gap is filled with one or more elastomeric materials. In some embodiments of the present disclosure the ratio of the extension of the part of the gap filled with one or more elastomeric materials over the total extension of the gap preferably is at least 0.25, more preferably at least 0.3 and especially preferably at least 0.5.

The elastomeric materials useful in the present disclosure broadly include any polymeric material which is capable of being formed into a thin film or sheet and which can be inserted between the bottom surface of the upper head section and the opposite top surface of the lower head section and which exhibits elastomeric properties at ambient conditions. Elastomeric preferably means that the polymeric material will substantially resume its original shape after being stretched. The elastomeric material or materials useful in the present disclosure will preferably sustain only small permanent set following stretching and relaxation which set preferably is less than 10%, more preferably less than 7.5% and especially preferably less than 5% of the original length at a moderate elongation of, for example, 50-100% The elastomeric materials used in the profiles of the present disclosure are preferably selected from one or more elastomeric materials selected from a group of materials comprising natural rubber, SIS block copolymers, SBS block copolymers, SEBS block copolymers, elastomeric polyurethanes, elastomeric silicone polymers, elastomeric ethylene copolymers including ethylene/vinyl acetate copolymers, elastomeric ethylene propylene copolymers, ethylene/propylene/diene elastomeric materials, elastomeric epoxy polymers, elastomeric 1K or 2K adhesives including elastomeric acrylate adhesives, elastomeric foams as well as blends of the foregoing polymers.

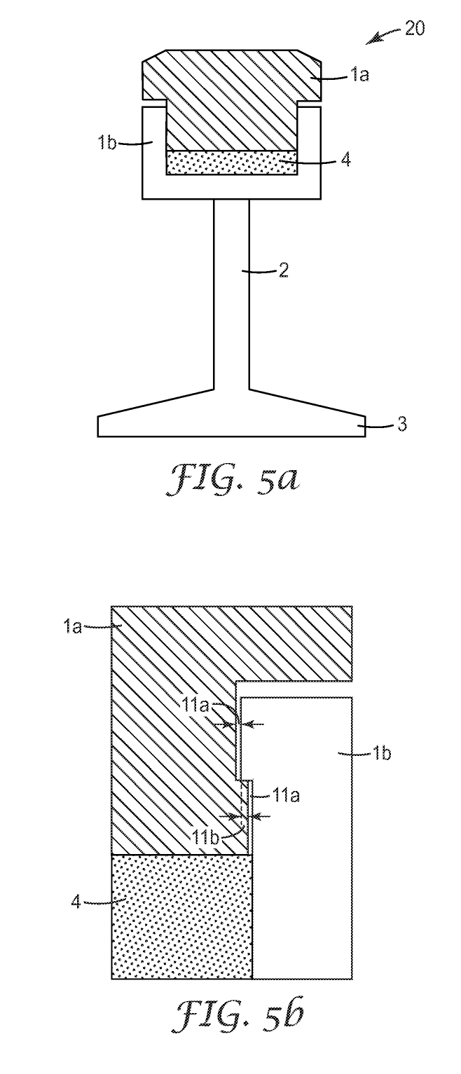

In the profiles of the present disclosure the sections of the gap which are filled with one or more elastomeric materials may extend in the horizontal direction or in the vertical direction, i.e. the gap may extend parallel to the vertical or horizontal direction or in an inclined direction. Elastomer-filled parts of the gap extending essentially vertically are mainly experiencing shear forces when subjecting the upper head section 1a to vertical (or normal) forces whereas elastomer-filled parts of the gap extending essentially horizontally are mainly experiencing compressive forces under such conditions. FIG. 3a exemplifies a profile having an elastomer-filled part of the gap essentially extending vertically whereas FIG. 5 is an example of a profile having an elastomer-filled part of the gap extending horizontally.

It was found by the present inventors that elastomer-filled sections of the gap mainly receiving shear forces preferably comprise one or more elastomeric materials having an E-module of between 1,000 and 8,000 N/cm² and more preferably between 1,500 and 6,000 N/cm². It was furthermore found that elastomer-filled parts of the gap mainly receiving compressive forces preferably comprise one or more elastomeric materials having an E-module of between 10,000 and 20,000 N/cm² and more preferably between 11,500 and 15,000 N/cm². Elastomer-filled sections of the gap extending obliquely relative to the horizontal and vertical direction, respectively, preferably comprise at least one elastomeric material having an E-module of between 1,000 and 8,000 N/cm² and at least one elastomeric material having an E-module of between 10,000 and 20,000 N/cm². Elastomer-filled sections of the gap mainly receiving compressive forces preferably comprise one or more elastomeric materials having a Poisson's ratio of between 0 and 0.3 and more preferably of between 0 and 0.2.

The horizontal width of vertical elastomer-filled sections of the gap may be essentially constant along their respective extension as is exemplarily illustrated, for example, in FIGS. 3a and 3b, or the horizontal width of the gap section may vary along such extension. In some exemplary embodiments illustrated, for example, in FIG. 3c, the width of the elastomeric filled gap section decreases in the direction of the movement of the upper head section to allow for a progressive spring suspension.

It is essential in the present disclosure that the gap between the upper head section 1a and the lower head section 1b extend in the vertical and horizontal direction. Gaps extending obliquely relatively to the vertical and horizontal direction are considered to extend both vertically and horizontally.

It was found that an extension of the gap in the horizontal direction is required so that the upper head section 1a can move vertically in response to a force acting upon the upper head section in the vertical (or normal) direction. The horizontally extending section of the gap can be elastomer-free as is shown, for example, in the embodiment of FIG. 2. In this embodiment vertical (normal) forces result in shearing the elastomeric material arranged in the vertical section of the “blade” of the sword-type profile, and the upper head section can move into the direction of the elastomer-free horizontal gap beneath the upper head section 1a to compensate for the shear displacement. The horizontally extending section (or part) of the gap can be elastomer-filled as is shown, for example, in the embodiment of FIG. 5 where vertical (normal) forces acting upon the upper head section result in a compression of the elastomeric material present in the elastomer-filled gap.

It was furthermore found that an extension of the gap in the vertical direction is required so that horizontal force components arising, for example, at junctions or while the railway vehicle is travelling through bends, are accommodated without resulting in an inacceptable horizontal displacement of the upper head section 1a.

In some embodiments of the profiles of the present disclosure the lateral displacement of the upper head section is limited by providing a gap having a vertically extending part with a small width of preferably between 0.03 and 1 mm and more preferably between 0.05 and 0.2 mm. When subjecting the profile to horizontal force components the upper head section may be displaced into contact with the lower head section 1b so that the horizontal force components are safely accommodated and cushioned via the base portion of the profile comprising the lower head section 1b, the web portion and the foot portion of the rail profile. In this embodiment the lateral displacement of the upper head section is essentially limited to the width of the small-width section of the gap as indicated above. The section of the gap having the small width is preferably arranged between the upper part of the upper head section 1a and the opposite surface of the lower head portion 1b as is shown, for example, in FIG. 3a. It is also possible, however, that the small-width part of the gap is arranged between other parts of the upper head section and the corresponding parts of the lower head section. The profile may preferably comprise 2 or more small width sections of the gap as is shown, for example, in FIG. 3c comprising two small-with sections of the gap.

In some embodiments of the profiles of the present disclosure the horizontal (lateral) displacement of the upper head section is limited by providing a gap having a vertically extending elastomer-filled part with a width of typically between 5 and 25 mm. Assuming, for example, horizontal compression and/or shear displacement of the elastomer filled gap of not more than 10% the lateral displacement will vary between 0.5 to 2.5 mm.

In some embodiments the rail profile of the present disclosure comprises a safety clearance between the bottom surface of the upper rail head section and the opposite surface of the lower rail head section to accommodate vertical overstress arising, for example, when a foreign material such as a nail or the like is present on the rail surface. The safety clearance preferably is at least 0.5 mm and more preferably between 0.5 and 1.5 mm.

In some embodiments of the present disclosure the dimensions of the upper head section 1a are chosen so that the product A×J^{1/3} of the area A of the profile of the upper head section 1a and the cubic root of the geometrical moment of inertia J of the profile of the upper head section 1a in the vertical direction is less than 230 cm^{10/3}.

Without wishing to be bound by such theory it is speculated by the present inventors that the noise generated by the wheels of railway vehicles rolling along the rail is based on the dynamic forces acting between the mass of the wheel and the axis of the railway vehicle and the mass of the rail. The forces from which the rolling noise results arise from the roughness of the contact areas between the wheel and the top surface of the upper railhead section the wheel is travelling on, from the stiffness of the contact between the wheel and the rail profile and from the acoustically relevant accelerated masses of the system wheel/rail which can be simulated as a spring-mass-system comprising springs and masses accelerated by the respective roughnesses of the rail wheel and the adjacent rail surfaces. While in the rails and rail profiles of the present disclosure the coupling between the wheel and the rail is not provided by the contact stiffness between the wheel and the rail which for steel wheels and rails is about 10⁹ N/m but by the elastomer mounting provided by the gap partially filled with one or more elastomeric materials it was recognized by the present inventors that a further noise reduction which meets practical requirements can only be obtained by controlling the acoustically relevant masses of the system wheel/rail or rail profile, respectively. The reduction of the relevant mass of the wheel of a railway vehicle is theoretically possible but practically extremely demanding because the relevant mass of the wheel is subject to mechanically stresses at any point in time while it is travelling along the rail whereas the relevant mass of the rail is only exposed to mechanical stress at the moment when the wheel is contacting it. The spring constant D between the upper and the lower head sections is preferably selected to be distinctly lower than the contact stiffness between the wheel and the rail. The spring constant D preferably is less than 5×10⁸ N/m, more preferably less than 2×10⁸ N/m and especially preferably not more than about 1×10⁸ N/m.

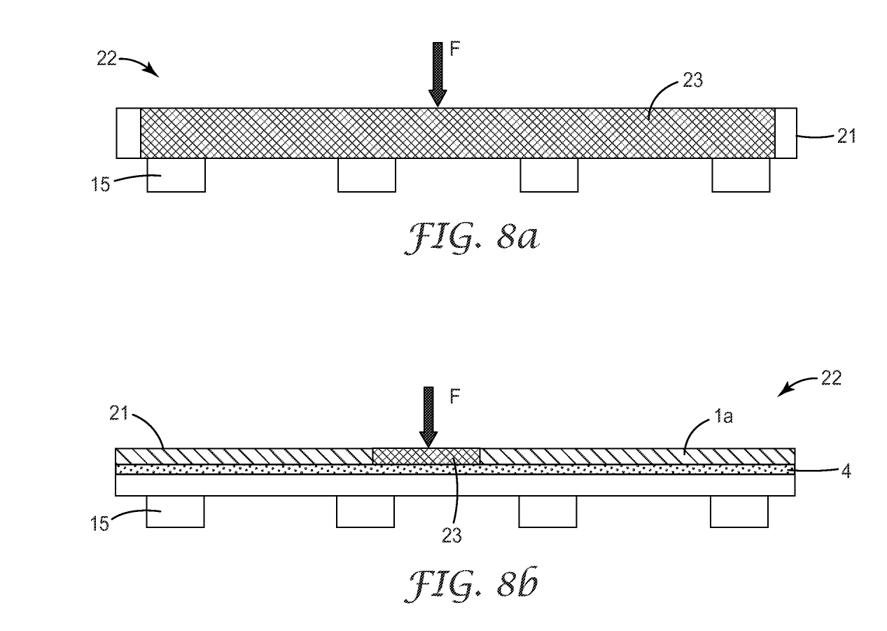

The acoustically relevant mass 23 of a rail of the state of the art which does not comprise an elastomer mounting is schematically shown in the side view FIG. 8a in comparison to the acoustically relevant mass 23 of a rail 21 or rail profile 20, respectively, comprising an elastomer mounting 4 (FIG. 8b). FIGS. 8a and 8b are side views of railway tracks 22 comprising a rail 21 mounted to sleepers 15. The normal dynamic forces acting on the rail 21 or the rail profile 20, respectively, when a railway vehicle is rolling along are indicated by the arrow normal to the upper surface of the rail profile 20. The state-of-the-art rail profile 20 of FIG. 8a which has a solid profile has an acoustically relevant mass 23 which is distinctly larger than the acoustically relevant mass 23 of the elastomer mounted rail profile 20 of FIG. 8. In practise the acoustically relevant mass 23 of solid rail profiles is at least about 2 m in length along the longitudinal direction whereas the acoustically relevant mass 23 of the elastomer-mounted rail may be an order of magnitude lower.

It was now found by the present inventors that the noise emitted by a elastomer-mounted rail profile can be reduced to a practically relevant level by controlling the geometrical dimensions of the rail profile.

Without wishing to be bound by such theory the inventors obtained the relevant mass of the elastomer-mounted profile as:

mᵣₑₗₑᵥₐₙₜ=Vᵣₑₗₑᵥₐₙₜ*ρ_{Stahl}=2*L*A_{ges}*ρ

wherein
m and V denoted the relevant mass or volume, respectively, of the average accelerated length L of the rail profile,
A is the area of the profile of the upper rail head section, and
ρ is the specific density of the material the upper and lower rail head sections are manufactured from such as, for example, steel.

The average accelerated length of an infinitely long profile having an upper and lower head section, respectively, being elastically mounted relative to each other via an elastomeric layer having a spring constant D is

$$L = \sqrt[3]{\frac{8 \cdot E \cdot J}{D}}$$

wherein
E is the E-Modul of the material the upper and lower rail head sections are manufactured from such as, for example, steel;
J is the geometrical moment of inertia J of the profile of the upper head section in the vertical direction; and
D is the spring constant between the upper rail head section and the lower rail head section.

Independently from such theoretical considerations it was found by the present inventors that elastomer-mounted profiles with a favourable rolling noise reduction properties are obtained, independently of the material used to manufacture the upper head section and the one or more elastomeric materials at least partly filling the gap between the upper and lower rail head, if the product of A×J^{1/3} is less than 230 cm^{10/3}, more preferably not more than 200 cm^{10/3} and especially preferably not more than 175 cm^{10/3}.

The geometrical moment of inertia J of the profile of the upper head section in the vertical direction provides a measure for its rigidity with respect to vertical bending and torsion forces. J is generally defined as

I_{y}=∫_{A}z²dA

wherein y is the horizontal (or axial) direction, z is the vertical direction and A is the area of the profile of the upper head section.

The horizontal geometrical moment of inertia J in the vertical direction can be easily calculated, for example, for upper head section profiles having a polygonic circumference. For a rectangularly shaped upper head section J is

J=b×h³/12

For a polygonically shaped upper head section profile the horizontal geometrical moment of inertia J can be obtained by dividing the upper head section into multiple rectangular profile parts. The entire moment of inertia can then be determined according to the so-called theorem by Steiner as the sum of the respective horizontal geometrical moments of inertia J of the multiple rectangular profile parts plus the sum of factors taking into account the respective vertical distance of the rectangular profile parts relative to the vertical center of gravity of the entire polygon area A.

Details on the calculation of the geometrical moment of inertia J of the profile of the upper head section in the vertical direction are disclosed, for example, in Gross, Hauger, Schnell: Technische Mechanik, vol. 2., Elastostatik, Springer Verlag, Berlin, pp. 75 or Dubbel, 21^{st} ed., p. C 13 which passages are included by reference into the present specification.

In some embodiments the upper head section is designed so as to protect the elastomeric material arranged in the gap between the upper and lower head section from the exposure to moisture, sun light, grease and/or other detrimental environmental impacts.

In some embodiments the upper head section has laterally extending projections covering the lower head section and the gap. In some embodiments at least the top section of the upper head section is snugly fitted into the corresponding opening of the lower head section so that the upper head section can essentially freely slide in the vertical direction but is metallically supported by the lower head section when subjected to a horizontal force. If desired, drainage channels may be provided between the gap and the outer surface of the lower section to allow for discharge of any ingressed moisture.

In some embodiments of the present disclosure the maximum extension of the profile of the upper head section in the vertical direction is higher than its maximum extension in the horizontal direction. The ratio of the maximum extension of the profile of the upper head section in the vertical direction over the maximum extension in the horizontal direction preferably is at least 1.5, more preferably at least 2 and especially preferably at least 2.5.

In some embodiments the upper head section exhibits a so-called “sword” profile having a bottom section (“blade”) and a top section (“handle bar”). The vertical extension of the blade is larger than that of the handle bar whereas the horizontal extension of the handle bar is larger than that of the blade. The length of the blade preferably is at least 5 cm and more preferably at least 7 cm. The geometrical dimensions of the handle bar are preferably selected so that the vertical surface or surfaces of the upper head section are separated from the opposite surfaces of the lower head section by a gap sufficiently small in width to allow for a metallic suspension in reply to horizontal forces.

It was found that sword-type profiles of the upper head section exhibit a low maximum tensile stress in the bottom section of the sword. This is advantageous because the allowable tensile stress of the material the upper head section is made of (e.g. steel) will safely be avoided in the blade of the sword. The sword-type profile used in Example 1.4 below exhibited, for example, a maximum tensile stress of not more than 16 N/mm² at the bottom section of the blade in reply to a force of, for example, 1*10⁵N. The transition between the handle bar and the blade must be reinforced to accommodate the notch stresses which may arise at such transition.

It was furthermore found that the blade can advantageously receive a layer of one or more elastomeric materials along both sides of its vertical extension as is exemplarily illustrated, for example, in FIGS. 3a and 3b. When a normal force is applied to the upper head section by the wheel of a railway vehicle the vertical elastomer-filled gap is exposed to a shear force. This shear suspension mode is advantageous compared to the compression suspension mode because the stress is equally distributed over the entire elastomer. Hence stress induced failure of the one or more elastomeric materials is less likely to occur.

In some embodiments the rail exhibits a so-called I-profile which optimally accommodates normal forces. The horizontal width of the top and bottom sections is wider than that of the intermediate section whereas the vertical height of the intermediate section exceeds that of the top and bottom sections, respectively, by a factor of preferably at least 1.5. The dimensions of the upper head section can be varied broadly as can be taken, for example, from the dimensions of the upper head sections exemplified in Example 1.

The maximum width of the upper head section in the horizontal direction preferably is not more than 8 cm, more preferably not more than 7 cm and especially preferably between 1 and 7 cm.

The maximum height of the upper head section in the vertical (or normal) direction preferably is less than 11 cm, more preferably less than 10 cm and especially preferably between 2 and 10 cm.

In some embodiments of the present disclosure the width and height of the upper profile cannot be chosen independently from each other but are chosen to provide the selected value of the product A×J^{1/3} which is set to be less than 230 cm^{10/3}

In a some embodiments of the profile of the present disclosure the upper head section 1a is removably attached to the lower head section 1b, i.e. the upper head section 1a can be removed from the lower head section 1b without non-elastically deforming or distorting such upper and/or lower head sections 1a,1b. The removal of the upper head section 1a from the lower head section may require, however, an adhesive or cohesive delamination of the upper and/or lower head section 1a, 1b from sections of the gap filled with one or more elastomeric materials 4.

The present disclosure also includes profiles in which the upper head section 1a cannot be removed from the lower head section 1b without non-elastically deforming or distorting such upper and/or lower head section. An example of such profile is shown in FIGS. 5a and 5b below. When inserting the upper head section 1a into the lower head section 1b the upper head section 1a snaps into place by mechanically engaging protrusions at the outer surface of the upper head sections 1a with corresponding protrusions at the inner surface of the lower head section 1b.

The rails 21 of the present disclosure may be manufactured by various methods.

In some embodiments, the present disclosure provides a method comprising the following steps.
(i) providing a lower portion of the rail comprising a foot portion, a web portion and a lower head section fixedly connected to the web portion,
(ii) providing an upper head section having a geometrical moment of inertia J in the vertical direction and an area A of its profile so that the product A×J^{1/3} is less than 230 cm^{10/3}, and
(iii) providing one or more elastomeric materials and arranging said one or more elastic materials between the upper and the lower head sections so that the upper and lower head sections are discontiguously separated from each other by a gap extending in the vertical and horizontal direction.

In some embodiments, there is provided a method of manufacturing a rail comprising the following steps.
(i) providing a lower portion of the rail comprising a foot portion, a web portion and a lower head section fixedly connected to the web portion,
(ii) providing an upper head section, and
(iii) providing one or more elastomeric materials and arranging said one or more elastic materials between the upper and the lower head sections so that the upper and lower head sections are discontiguously separated from each other by a gap extending in the vertical and horizontal direction whereby the gap has at least a first gap section comprising said one or more elastomeric materials and at least a second gap section which is essentially free of said one or more elastomeric materials and has a width which is small enough so that the upper head section contacts the lower head section in the area of such second gap section when subjecting the rail to horizontal forces exerted by the rail vehicle.

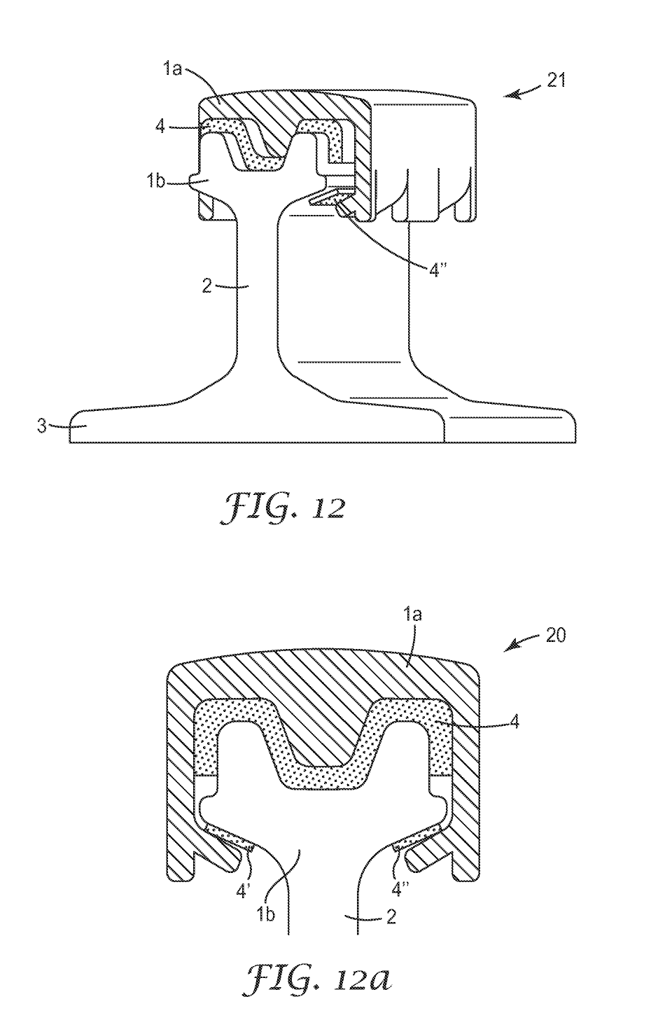

In some embodiments of the present disclosure, the method comprises providing a lower portion of a rail comprising a foot portion, a web portion and a lower head section is provided in a first step. Then one or more elastomeric strips or tapes are attached to the exposed surface or surfaces of the lower head section, and the upper head section is slid onto the elastomeric material and the lower head section as is illustrated, for example, in FIGS. 11 and 12. This method also allows for the replacement of worn out upper head sections in the field which is advantageous.

In some embodiments, the upper head section may be assembled to the lower head section first without including one or more elastomeric materials in the gap between the upper and lower head sections. Then, in a second step, a liquid precursor of the elastomeric material is filled into the respective sections of the gap, for example, via filling holes which may be arranged in the upper/and or lower head section. Such filling holes are preferably arranged in regular distances along the longitudinal direction of the rail. The precursor of the elastomeric material can subsequently be cured, for example, by heat (which may be generated when welding standard rail lengths to form a railway track) or by ambient moisture, for example.

If desired, the exposed opposing surfaces of the lower and upper head section, respectively, are cleaned and/or treated with corona treatment and/or chemical primers prior to applying the one or more elastomeric materials and/or their respective precursors, respectively.

FIG. 1 schematically shows a conventional cross-sectional Vignol-type rail profile of the prior art having a rail head portion 1, a rail web portion 2 and a rail foot portion 3 which can be mounted to sleepers of the railway track (not shown). It is furthermore schematically shown how the wheel rim 30 of a railway vehicle running along the rail is contacting the top surface of the rail head portion 1. The side of the profile where the wheel rim is overhanging the side of the rail head portion is facing towards the railway vehicle. This side is also generally referred to above and below as the inner side of the rail profile 20. The opposite side of the rail head is also generally referred to above and below as the outer side of the rail profile 20.

FIG. 2a-FIG. 2d schematically show embodiments of rail profiles of the present disclosure wherein the gap between the upper head section 1a and the lower head section 1b is in each case essentially completely filled with one or more elastomeric materials 4. The gap furthermore in each case has essentially a constant width over its extension in the vertical and the horizontal direction, respectively. The rail profiles of FIGS. 2a-2d each exhibit a web portion 2 arranged between the lower head section 1b and the foot portion 3.

In the embodiments of both FIG. 2a and FIG. 2b the upper head sections 1a essentially have a rectangular shape. In FIG. 2a the gap exhibits an L-shape reflecting the L-shaped form of the lower head section 1b. The shorter section of the L of the lower head section 1b is arranged adjacent to the outer side of the rail profile and extends in the vertical direction so that it accommodates, via the vertical section of the elastomer-filled gap, components of forces acting on the upper head section in a horizontal direction towards the outer side of the rail profile. Such horizontal force components can arise, for example, at junctions or when the railway vehicle is travelling through bends. In FIG. 2b the lower head section 1b and the gap are essentially U-shaped and each exhibit two short sections extending in the vertical direction. The horizontal sections of the gap and the lower head section 1b in FIGS. 2a and 2b mainly receive normal compression forces arising, for example, in straight sections of the railway track.

The profile of FIG. 2c is similar to that of FIG. 2b with the difference being that the upper head section 1a has a T-shape rather than a rectangular shape as in FIG. 2b. The lateral progressions of the T of the upper head section 1a cover the vertically extending sections of the gap thus protecting them from rain and other environmental impacts.

In the embodiment of FIG. 2d the upper head section 1a and the adjacent gap filled with elastomeric materials 4 exhibit the shape of an inverted U whereas the lower head section 1b has the shape of an inverted T. In the profile of FIG. 2d normal forces are thus acting on the vertically extending section of the T of the lower head section 1b on the inner side of the profile. The upper head section 1a of the embodiment of FIG. 2d covers the elastomeric material 4 filling the gap and thus protects it against environmental impacts.

The embodiments of FIGS. 2a-2d accommodate horizontal forces thereby reducing the horizontal displacement of the upper head section 1a resulting from horizontal force components acting upon the upper head section 1a.

FIGS. 3a-3b schematically show embodiments of rail profiles 20 of the present disclosure where the extension of the upper head section 1a in the vertical direction is distinctly longer than the maximum extension of the upper head section 1a in the horizontal direction.

In the embodiments of FIGS. 3a and 3b, the upper head section 1a exhibits a sword-type configuration. The upper head section 1a has a top section (the “handle bar”) having a width essentially corresponding to the width of the opening in the lower head section except for the narrow vertical gap sections between the surfaces of the opening of the lower head section and the opposite vertical surfaces of the top section of the upper head section. This gap section, which forms part of the gap between the upper head section 1a and the lower head section 1b is wide enough so that the top section of the upper head section 1a can essentially freely move into the opening of the lower head section 1b in response to a normal force acting on the upper head section 1a. It is also small enough so that the top section of the upper head section 1a contacts the opposite surface of the lower rail head section 1b in response to a normal (vertical) force component applied to the upper head section 1a by the wheel and the axis of the wheel of a railway vehicle, for example, in a bend. The bottom section of the upper head section 1a (“the blade”) is distinctly shorter in width in comparison to the width of the top section of the upper head section 1a. The gap between the bottom section of the upper head section 1a and the inner surface of the opening of the lower head section 1b is filled with one or more elastomeric materials 4 which shear into the vertical direction in response to a normal (vertical) force acting upon the upper head section 1a. The horizontal section of the gap is not filled with an elastomeric material so the elastomeric material 4 arranged next to the blade can expand into that empty gap section when subjected to shear forces.

The embodiment of FIG. 3b differs from that of FIG. 3a in that the top section of the upper head section 1a has a different geometry. It can be seen that the top section extends further inwardly, and the vertical side piece of the lower head section 1b at the inner side is correspondingly shortened to accommodate the enlarged top section of the upper head section 1a. The bottom surface of the top section of the upper head section 1a and the opposite surface of the side piece of the lower head section 1b are separated by a gap section providing a safety clearance to accommodate vertical overstress arising, for example, when a foreign material such as a nail or the like is present on the rail surface.

The embodiment of FIG. 3c differs from that of FIG. 3a in that the upper head section 1a does not have a “sword” profile but an I-profile. Accordingly, the upper head section 1a has a top section and a bottom section which are distinctly wider in the horizontal direction than an intermediate section that connects the top and bottom sections, respectively. The I-profiled upper head section 1a can be inserted into the opening of the lower head section 1b. The connection between the top sections and the intermediate section, respectively, of the upper head section 1a is somewhat enlarged in comparison to the width of the remainder of the middle section and hence reinforced to avoid mechanical damage from notch stresses. The gap section directly beneath the top section of the upper head section 1a is not filled with one or more elastomeric materials so that the upper head section can be moved without contacting its top section with elastomeric materials 4.

As in the embodiment of FIG. 3a, FIG. 3c provides the gap sections between the top and bottom sections of the upper head section 1a and the inner surface of the opening of the lower head section 1b, respectively, are wide enough so that the top section of the upper head section 1a can essentially freely move into the opening of the lower head section 1b in response to a normal force acting on the upper head section 1a, and they are small enough so that the top section of the upper head section 1a gets in contact with the opposite surface of the lower head section 1b in response to a horizontal force component applied to the upper head section 1a by the wheel and the axis of the wheel of a railway vehicle, for example, in a bend. Likewise, the gap section between the intermediate section of the upper head section 1a and the inner surface of the opening of the lower head section 1b is filled with one or more elastomeric materials 4 which shear into the vertical direction in response to a normal force acting upon the upper head section 1a.

The embodiment of FIG. 3d differs from that of FIG. 3c in that the width of the gap section between the intermediate section of the upper head section 1a and the inner surfaces of the opening of the lower head section, respectively, which is filled with one or more elastomeric materials 4, has a horizontal width which is decreasing vertically in the direction of the movement of the upper head section 1a to allow for a progressive cushioning.

The embodiment of FIG. 4 is similar to the embodiment of FIG. 3d with the difference that a sword-type profile is used instead of an I-type profile. The gap section directly beneath the top section of the upper head section 1a which is not filled with one or more elastomeric materials, is connected via draining channels 6 to the outer surface of the lower head section 1b so that moisture can be discharged. Furthermore, the top section of the upper head section 1a and the lower head section 1b are electrically connected via metal wires 7 arranged in the elastomer-free gap section directly beneath the top section of the upper head section 1a.

The embodiment of a rail profile 20 of the present disclosure as schematically shown in FIG. 5a comprises a gap having a narrow vertical gap section between the inner surfaces of the opening of the lower head section 1b and the opposite vertical surfaces of the upper head section 1a and a wider lower horizontal gap section arranged between the bottom surface of the upper head section 1a and the opposite inner bottom surface of the lower head section 1b. The gap furthermore has upper horizontal sections between the top surfaces of the side pieces of the lower head section and the opposite bottom surfaces of the lateral projections of the upper head section, respectively.

The vertical gap section is shown in some more detail in FIG. 5b. The vertical gap section 11a has a width that is wide enough so that the upper head section 1a can essentially freely move into the opening of the lower head section 1b in response to a normal force acting on the upper head section 1a, and that is small enough so that the upper head section 1a gets pushed in contact in response to a horizontal force component applied to the upper head section 1a from the wheel and the axis of the wheel of a railway vehicle, for example, in a bend. It can be seen that the upper and lower sections, respectively, of the vertical gap section 11a are offset relative to each other by a distance 11b so that the upper head section 1a can be snapped into place relative to the lower head section 1b. Thus the upper head section 1a can be secured and locked into place relative to the lower head section 1b. The snapping step can be performed elastically without damaging the upper and/or lower head sections, respectively, if the offset is chosen small enough (e.g. 0.2-0.5 mm for a rail profile with standard dimensions).

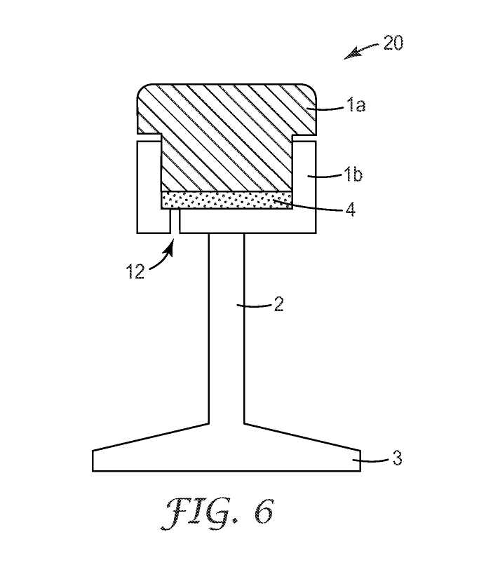

The embodiment of FIG. 6 is similar to the embodiment of FIG. 5a with the difference that a filling hole 12 is provided in the bottom section of the lower head section 1b. A liquid precursor of the one or more elastomeric materials 4 can be filled into the horizontal section of the gap section beneath the bottom surface of the upper head section 1a. Subsequently, the precursor can be cured, for example, by thermal or moisture curing to provide the elastomeric material(s)₄. Advantageously filling holes 12 can be arranged in regular distances along the longitudinal direction of the rail profile 20.

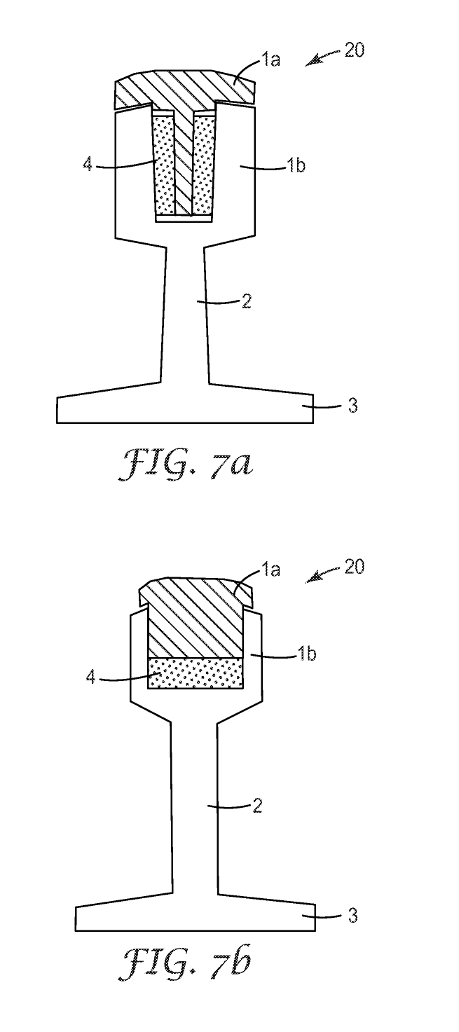

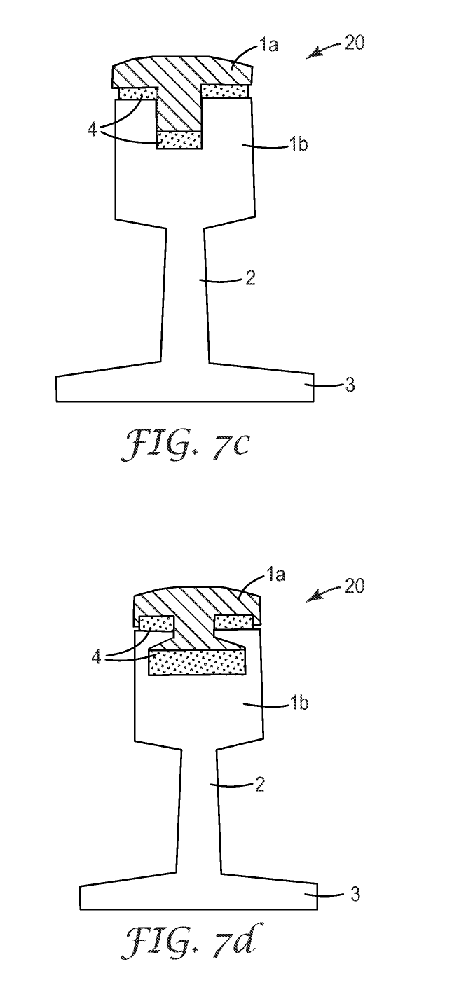

FIGS. 7a-7d schematically show further embodiments of rail profiles 20 of the present disclosure.

The profile of FIG. 7a is similar to that of FIG. 4 whereby the geometry of the sword-type upper head section 1a has been modified in that the two lateral projections of the upper head section 1a cover the two vertical side pieces of the lower head section 1b to obtain a better protection of the elastomeric material 4 against environmental impacts. The bottom section of the “handle bar” of the sword-type profile is separated by a vertical gap from the lower head section 1b which is small in width to allow for an accommodation of horizontal forces by the lower head section 1b. The vertical extension of such narrow gap section has been reduced in comparison to the embodiment of FIG. 4.

The profile of FIG. 7b is similar to that of FIG. 5a whereby the geometry of the two lateral projections of the upper head section 1a have been slightly modified to obtain a better protection of the elastomeric material 4 against environmental impacts.

In the profile of FIG. 7c the upper head section has a T-shaped form. The horizontal sections of the gap have a wide width and are filled with one or more elastomeric materials 4 whereas the vertical gap section has a narrow width to allow for an accommodation of horizontal forces by the lower head section 1b.

The profile of FIG. 7d is similar to that of FIG. 7c with the difference that the bottom section of the upper head section 1a is enlarged to exhibit a “dove-tail” shape which engages with and is retained by the inwardly protruding wings of the top section of the lower head section 1b.

FIGS. 8a and 8b are schematic views of the outer side of a railway track 22 comprising in each case a rail 21 mounted to sleepers 15. FIG. 8a schematically shows the acoustically relevant accelerated mass 23 of a state of the art rail profile of, for example, FIG. 1, whereas FIG. 8b schematically depicts the acoustically relevant accelerated mass 23 of a corresponding rail profile 20 of the present disclosure such as that of, for example, FIG. 7c. It can be seen that the rail profiles 20 of the present disclosure exhibit a distinctly lower acoustically relevant accelerated mass 23 than comparable state of the art profiles.

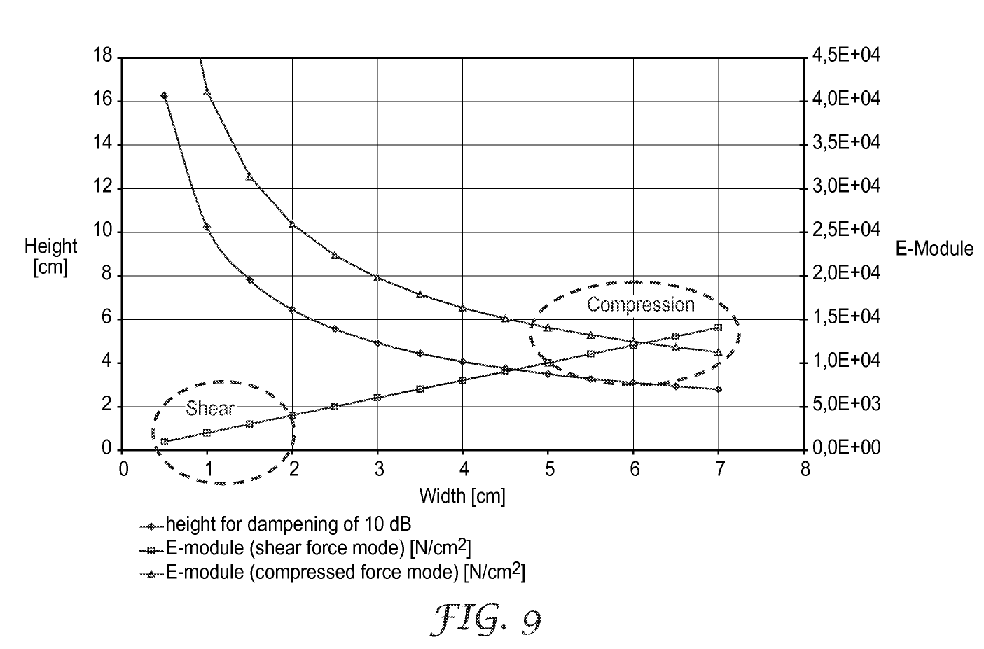

FIG. 9 is a plot of results described in detail in Example 2 below.

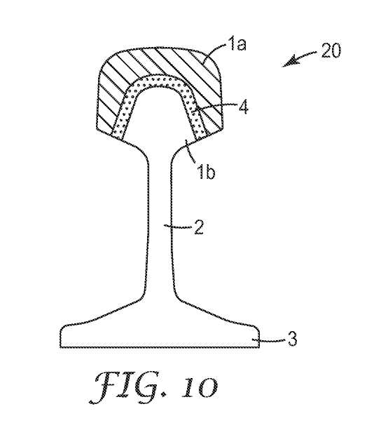

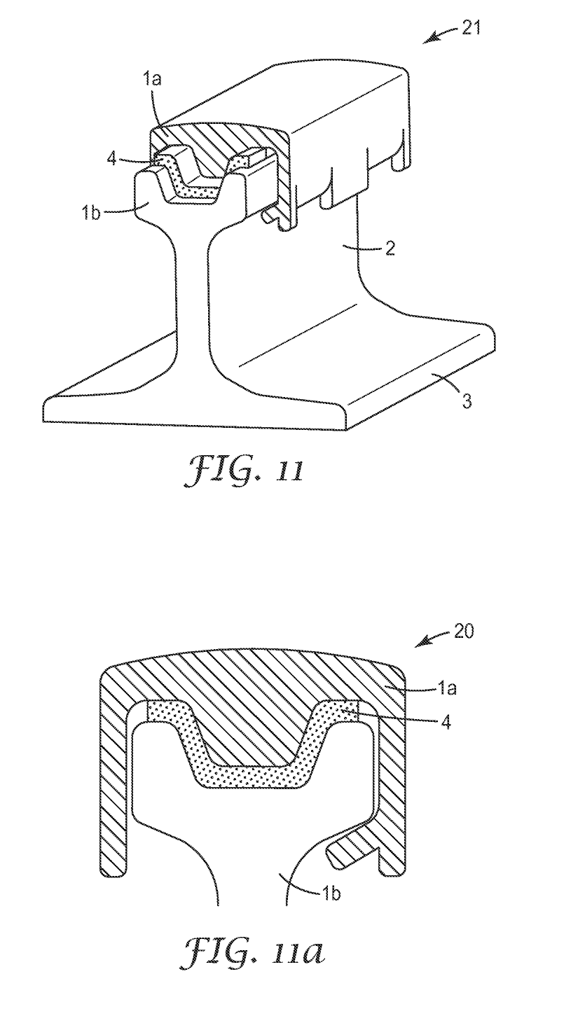

FIG. 10 shows a further embodiment of a rail profile 20 of the present disclosure wherein the gap separating the upper and the lower head sections 1a, 1b is completely filled with one or more elastomeric materials 4.

FIG. 11 is a schematic perspective view of a rail 21 having an upper head section 1a that has two vertical side pieces extending beyond the lower head section 1b. FIG. 11a is a schematic view of the cross-sectional rail profile 20 of the rail 21 of FIG. 11. One of the vertical side pieces of the upper head section 1a has an inwardly extending projection securing the upper head section 1a to the lower head section 1b. The gap between the upper and the lower head sections, respectively, has a horizontal upper section which is filled with one or more elastomeric materials 4 and vertical sections which are free of an elastomeric material. The vertical gap sections are narrower in width than the horizontal, elastomer-filled gap section to allow for an accommodation of horizontal forces by the lower head section 1b. It is indicated in FIG. 11a that the upper head section 1a can be slid on the elastomeric layer 4 and the lower head section 1b. This is advantageous because it allows to replace worn out upper head sections 1a in the field with new upper head sections 1a.

FIG. 12 is a schematic perspective view of a rail 21 which has a rail profile 20 shown in FIG. 12a. The rail 20 of FIGS. 12, 12a is similar to the embodiment of FIGS. 11, 11a with the differences that
the shape of the upper head section 1a is modified and exhibits two humps,
the vertical side pieces of the upper head section 1a overhanging the lower head section 1b both exhibit projections securing the upper head section 1a to the lower head section 1b
the gap between the upper and lower head sections 1a, 1b exhibits three sections filled with elastomeric materials 4,4′ and 4″, and
the length of the vertical section of the gap which is relatively narrow in width and elastomer-free is reduced.

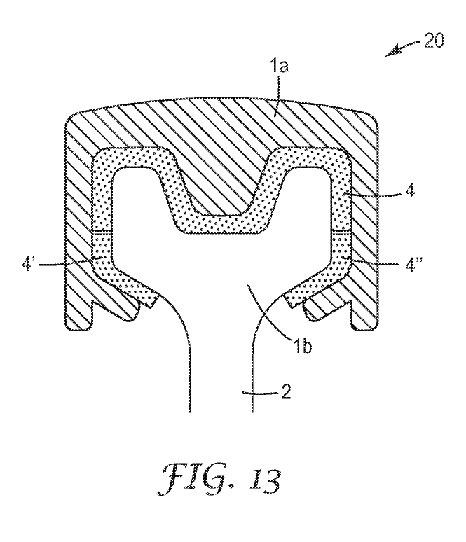

FIG. 13 schematically shows a rail profile similar to that of FIG. 12a with the difference that the gap between the upper and lower head sections 1a, 1b is essentially constant in width over its extension and essentially completely filled with different elastomeric materials 4, 4′ and 4″.

Following are exemplary embodiments of the present disclosure:
1. Rail having a longitudinal direction defined by the rolling direction of a wheel of a rail vehicle along the rail, and a cross-sectional profile arranged normally to the longitudinal direction and having a vertical and a horizontal direction, the rail profile having a foot portion, a web portion and a head portion wherein the head portion has a lower head section fixedly connected to the web portion and an upper head section, the lower head section and the upper head section being separated from each other by a gap extending in the vertical and the horizontal direction, the gap comprising one or more elastomeric materials and the upper head section having a geometrical moment of inertia J in the vertical direction and an area A of the profile so that the product A×J^{1/3} is less than 230 cm^{10/3}.
2. Rail having a longitudinal direction defined by the rolling direction of a wheel of a rail vehicle along the rail, and a cross-sectional profile arranged normally to the longitudinal direction and having a vertical and a horizontal direction, the rail profile having a foot portion, a web portion and a head portion wherein the head portion has a lower head section fixedly connected to the web portion and an upper head section, the lower head section and the upper head section being separated from each other by a gap extending in the vertical and the horizontal direction, the gap having at least a first gap section comprising one or more elastomeric materials and at least a second gap section having a width which is small enough so that the upper head section contacts the lower head section in the area of such second gap section when subjecting the rail to horizontal force components exerted by the rail vehicle.
3. Rail according to claim 1 wherein the product A×J^{1/3} is less than 100 cm^{10/3}.
4. Rail according to any of the preceding claims wherein the displacement of the upper head section relative to the lower head section in the vertical direction when subjected to a force in the vertical direction of 1×10⁵ N relative to the position of the upper head section when no vertical force is present, is less than 2 mm.
5. Rail according to any of the preceding claims wherein the gap is at least partially bordered by the lower head section on the outer side of the profile facing away from the rail car.
6. Rail according to any of the preceding claims wherein the gap between the upper head section and the lower head section has one or more sections having a width of at least 10 mm.
7. Rail according to claim 6 wherein the sections of the gap between the upper head section and the lower head section having a width of at least 10 mm are essentially completely filled with one or more elastomeric materials.
8. Rail according to any of claims 2 to 7 wherein the gap between the upper head section and the lower head section has one or more sections having a width of less than 0.25 mm.
9. Rail according to claim 8 wherein the sections of the gap between the upper head section and the lower head section having a width of less than 0.25 mm are essentially free of any elastomeric materials.
10. Rail according to any of claims 8 to 9 wherein the sections of the gap between the upper head section and the lower head section having a width of less than 0.25 mm comprises a lubricant or a ductile metal.
11. Rail according to any of the preceding claims having a safety clearance beneath the bottom surface of the upper rail head section and the opposite surface of the lower rail head section of at least 0.5 mm.
12. Rail according to any of the preceding claims wherein the gap is essentially L-shaped and comprises a first side essentially extending in parallel to the foot section and a second side essentially normal to the first side, said second side at least partially bordered by the lower head section.
13. Rail according to any of the preceding claims wherein the maximum extension of the profile of the upper head section in the vertical direction is higher than its maximum extension in the horizontal direction.
14. Rail according to claim 13 wherein the maximum extension of the profile of the upper head section in the vertical direction is at least 5 cm
15. Rail according to any of claims 5 to 14 wherein the gap also is at least partially bordered by the lower head section on the side of the profile facing towards the rail car.
16. Rail according to claim 15 wherein the gap essentially is U-shaped and comprises a first side essentially extending in parallel to the foot section and a second and third side both arranged essentially normal to the first side, said second and third sides at least partially bordered by the lower head section facing away or towards the rail car, respectively.
17. Rail according to any of the preceding claims wherein the upper head section and the lower head section are electrically connected.
18. Rail according to any of the preceding claims comprising a drainage connection between the gap and the outer surface of the rail.
19. Rail according to any of the preceding claims wherein the gap and/or the one or more elastomeric materials comprised by the gap are shaped to allow for a progressive force.
20. Rail according to any preceding claim wherein the gap comprises an elastomeric material having an elasticity modulus E of between 100 and 140 MPa.
21. Rail according to any preceding claim wherein the gap comprises an elastomeric material having an elasticity modulus E of between 10 and 40 MPa.
22. Rail according to any of claims 20 to 21 wherein the gap comprises at least one elastomeric material having an elasticity modulus E of between 100 and 140 MPa and at least one elastomeric material having an elasticity modulus E of between 10 and 40 MPa.
23. Rail according to any preceding claim wherein the one or more elastomeric materials comprised in the gap each exhibit a permanent set of less than 10%.
24. Rail according to any preceding claim wherein the gap comprises one or more elastomeric materials selected from a group of materials comprising natural rubber, SIS block copolymers, SBS block copolymers, SEBS block copolymers, elastomeric polyurethanes, elastomeric silicone polymers, elastomeric ethylene copolymers including ethylene/vinyl acetate copolymers, elastomeric ethylene propylene copolymers, ethylene/propylene/diene elastomeric materials, elastomeric epoxy polymers, elastomeric 1K or 2K adhesives including elastomeric acrylate adhesives, elastomeric foams as well as blendes of the foregoing polymers.
25. Method of manufacturing a rail comprising the following steps.
   (i) providing a lower portion of the rail comprising a foot portion, a web portion and a lower head section fixedly connected to the web portion,
   (ii) providing an upper head section having a geometrical moment of inertia J in the vertical direction and an area A of the profile so that the product A×J^{1/3} is less than 230 cm^{10/3}, and
   (iii) providing one or more elastomeric materials and arranging said one or more elastic materials intermediate between the upper and the lower head sections so that the upper and lower head sections are discontiguously separated from each other by a gap extending in the vertical and horizontal direction.
26. Method of manufacturing a rail comprising the following steps.
   (i) providing a lower portion of the rail comprising a foot portion, a web portion and a lower head section fixedly connected to the web portion,
   (ii) providing an upper head section, and
   (iii) providing one or more elastomeric materials and arranging said one or more elastic materials intermediate between the upper and the lower head sections so that the upper and lower head sections are discontiguously separated from each other by a gap extending in the vertical and the horizontal direction whereby the gap has at least a first gap section comprising said one or more elastomeric materials and at least a second gap section which is essentially free of said one or more elastomeric materials and has a width which is small enough so that the upper head section contacts the lower head section in the area of such second gap section when subjecting the rail to horizontal forces exerted by the rail vehicle.

The present disclosure is further illustrated by the following non-limiting Examples which are based on theoretical calculations.

### EXAMPLES

### Example 1

The geometry of the profile of the upper head section was varied as indicated in Table 1 below while maintaining the product A×J^{1/3} constant. The upper head sections consisted in each case of steel.

In Examples 1.1 to 1.3 the upper head section had a profile according to FIG. 2a; the dimensions of the rectangular cross-section are given in Table 1. In Examples 1.4-1.5 the upper head section had the sword-type configuration of the profile schematically shown in FIG. 3a. The E-module of the elastomeric material and the width of the gaps were selected in each case so as to provide a spring constant D between the upper and the lower head sections of essentially 1×10⁸ N/m.

The noise reduction obtained by the profiles of Examples 1.1 to 1.5 in comparison to a solid profile obtained by omitting the elastomer filled gap and joining the upper and lower head sections, respectively, was in each case 10 dB.

In Examples 1.6-1.11 the profile according to FIG. 2a was used whereby the geometry of the rectangular upper head section was varied as indicated in Table 2 below. The gap was completely filled in each case with an elastomeric material. The E-module of the elastomeric material and the width of the gap were selected in each case so as to provide a spring constant D between the upper and the lower head sections of essentially 1×10⁸ N/m.

The noise reduction obtained by the profiles of Examples 1.6 to 1.11 in comparison to a solid profile obtained by omitting the elastomer filled gap and joining the upper and lower head sections, respectively, was in each case 7 dB.

Example 1 is based on theoretical considerations. The corresponding experimental measurements can be made, however, using the test method disclosed in M. Hecht, M. Löffler, C. Gramowski, “Rollgeräuschreduktion durch innovative Schienkonstruktion” (Reduction of Rolling Noise by an Innovative Rail Construction), EI-Eisenbahningenieur, August 2008, pp. 6-10.

TABLE 1
Geometries of the upper head section for 10 dB damping

| Example | 1.1 | 1.2 | 1.3 | 1.4 | 1.5 |
|---|---|---|---|---|---|
| Geometries | rectan- | rectan- | rectan- | Sword | I-Profile |
| of profile of | gular | gular | gular | (with | (with |
| upper head | | | | upper | upper and |
| section | | | | head, | lower head, |
| | | | | FIG. 3a) | FIG. 3c) |
| width*height | 7*2.8 | 2*6.46 | 1*10.25 | — | — |
| [cm²] | | | | | |
| width*height | — | — | — | 2*2/ | — |
| of handle | | | | 0.5*10.2 | |
| bar/sword | | | | | |
| width*height | — | — | — | — | 2*1.5/ |
| of upper head/ | | | | | 0.5*8.1/2*1 |
| intermediate | | | | | |
| section/lower | | | | | |
| head | | | | | |
| A/cm² | 19.6 | 12.91 | 10.25 | 9.09 | 9.05 |
| J/cm\hat{ }4 | 12.81 | 44.82 | 89.64 | 128.4 | 130.2 |
| {cube root}J × A_{ges}/cm^{10/3} | 45.85 | 45.85 | 45.85 | 45.85 | 45.85 |

TABLE 2
Geometries of the upper head section for 7 dB damping

| | Example | | | | | |
|---|---|---|---|---|---|---|
| | 1.6 | 1.7 | 1.8 | 1.9 | 1.10 | 1.11 |
| Geometries of | rectangular | rectangular | rectangular | rectangular | rectangular | rectangular |
| profile of upper head | | | | | | |
| section | | | | | | |
| Profil b * h | 7 * 4.0 | 2 * 9.1 | 1 * 14.5 | 11.8 * 2.8 | 3.4 * 6.4 | 1.7 * 10.25 |
| A/cm² | 27.7 | 18.2 | 14.5 | 33 | 21.8 | 17 |
| J/cm\hat{ }4 | 36.2 | 126 | 253 | 21.5 | 74.6 | 151 |
| {cube root}J × A_{ges}/cm\hat{ }(10/3) | 91.7 | 91.7 | 91.7 | 91.7 | 91.7 | 91.7 |

### Example 2

The geometry of a rectangular upper head section having a geometry as shown in FIG. 2b was varied by varying the height of the profile in the vertical (z) direction and the width in the horizontal (y) direction while maintaining constant the product A×J^{1/3} at a value of 45,85. The upper head section was made of steel. The E-module of the elastomeric material and the width of the gap were selected in each case so as to provide a spring constant essentially of 1×10⁸ N/m.

It was found that the gap between the upper and the lower head sections, respectively, were advantageously filled—depending on the geometry of the upper head section—with different elastomeric materials exhibiting different values of the E modulus.

It can be taken, for example, from FIG. 9 that a rectangular profile with a width of 1 cm which has a height of 10.25 cm, can be suspended with low modulus material with an E modulus of approximately 2×10³ N/cm² when the elastomer is arranged so that it is subjected to shear forces. It can also be taken from FIG. 9 that a rectangular profile with a width of 7 cm which has a height of 2.8 cm, can be suspended with high modulus material with an E modulus of approximately 1.1×10⁴ N/cm² when the elastomer is subjected to compression forces.

When using the low modulus material this was arranged in the two vertical sections of the gap whereas the horizontal section of the gap was not filled with an elastomeric material. When applying a normal (vertical) force of about 1×10⁵N to the upper head section the low modulus elastomeric material was mainly exposed to shear forces.

It was, however, also possible to fill the horizontal section of the gap with the high modulus elastomeric material while not filling the vertical sections of the gap with an elastomeric material.

The noise reduction obtained in both cases was about 10 dB in comparison to a solid profile obtained by omitting the gap and joining the upper and lower head sections, respectively. It was found, however, that the embodiment having a low modulus elastomeric material arranged along the vertical section of the gap was advantageous because it had a better stress distribution along the relatively long vertical sections of the gap in comparison to the high modulus material arranged in the relatively short horizontal section of the gap.

It can likewise be taken from FIG. 9 that a rectangular profile with a width of 6 cm which had a height of 5 cm, can be suspended with an elastomeric material with an E modulus of approximately 1.2×10⁴ N/cm² both in the vertical sections or the horizontal sections of the gap, respectively. For this specific embodiment the same elastomeric material could be used both in a shear and a stress dominated regime, respectively. If the elastomeric material is used in both gaps at the same time, the E-Module should be set to 0.6×10⁴ N/cm² in order to obtain the same spring constant D between the upper and the lower head sections.

The noise reduction obtained in the cases was about 10 dB in comparison to a solid profile obtained by omitting the gap and joining the upper and lower head portions, respectively. It is found, however, that the embodiment having a low modulus elastomeric material arranged along the vertical portion of the gap is advantageous because it has a better stress distribution along the relatively long vertical portion of the gap in comparison to the high modulus material arranged in the relatively short horizontal portions of the gap.

Other embodiments of the rectangulary shaped upper head section and the selection of the elastomeric material suitable in a shear or stress dominated regime, respectively, can be taken from the plot of FIG. 9.

Example 2 is based on theoretical considerations. The corresponding experimental measurements can be made, however, using the test method disclosed in M. Hecht, M. Löffler, C. Gramowski, “Rollgeräuschreduktion durch innovative Schienkonstruktion” (Reduction of Rolling Noise by an Innovative Rail Construction), EI-Eisenbahningenieur, August 2008, pp. 6-10.

1. A rail having a longitudinal direction defined by a rolling direction of a wheel of a rail vehicle along the rail, and a cross-sectional profile arranged normally to a longitudinal direction and having a vertical and a horizontal direction, the rail cross-sectional profile having a foot portion, a web portion and a head portion wherein the head portion has a lower head section fixedly connected to the web portion and an upper head section, the lower head section and the upper head section being separated from each other by a gap extending in the vertical direction and the horizontal direction, the gap comprising one or more elastomeric materials and the upper head section having a geometrical moment of inertia J in the vertical direction and an area A of the profile so that the product A×J^{1/3} is less than 230 cm^{10/3}.

2. A rail having a longitudinal direction defined by a rolling direction of a wheel of a rail vehicle along the rail, and a cross-sectional profile arranged normally to a longitudinal direction and having a vertical and a horizontal direction, the rail cross-sectional profile having a foot portion, a web portion and a head portion wherein the head portion has a lower head section fixedly connected to the web portion and an upper head section, the lower head section and the upper head section being separated from each other by a gap extending in the vertical direction and the horizontal direction, the gap having at least a first gap section comprising one or more elastomeric materials and at least a second gap section having a width which is small enough so that the upper head section contacts the lower head section in the area of the second gap section when subjecting the rail to horizontal force components exerted by the rail vehicle.

3. A rail according to claim 1 wherein the product A×J^{1/3} is less than 100 cm^{10/3}.

4. A rail according to claim 1 wherein the displacement of the upper head section relative to the lower head section in the vertical direction when subjected to a force in the vertical direction of 1×10⁵ N relative to the position of the upper head section when no vertical force is present, is less than 2 mm.

5. A rail according to claim 1 wherein the gap is at least partially bordered by the lower head section on an outer side of a profile facing away from the rail car.

6. A rail according to claim 1 wherein the gap between the upper head section and the lower head section has one or more sections having a width of at least 10 mm.

7. A rail according to claim 6 wherein the sections of the gap between the upper head section and the lower head section having a width of at least 10 mm are essentially completely filled with one or more elastomeric materials.

8. A rail according to claim 2 wherein the gap between the upper head section and the lower head section has one or more sections having a width of less than 0.25 mm.

9. A rail according to claim 8 wherein the sections of the gap between the upper head section and the lower head section having a width of less than 0.25 mm are essentially free of any elastomeric materials.

10. A rail according to claim 8 wherein the sections of the gap between the upper head section and the lower head section having a width of less than 0.25 mm comprises a lubricant or a ductile metal.

11. A rail according claim 1 having a safety clearance beneath a bottom surface of the upper rail head section and an opposing surface of the lower rail head section of at least 0.5 mm.

12. A rail according claim 1 wherein the gap is essentially L-shaped and comprises a first side essentially extending in parallel to the foot section and a second side essentially normal to the first side, said second side at least partially bordered by the lower head section.

13. A rail according claim 1 wherein a maximum extension of the profile of the upper head section in the vertical direction is higher than its maximum extension in the horizontal direction.

14. A rail according to claim 13 wherein a maximum extension of the profile of the upper head section in the vertical direction is at least 5 cm

15. A rail according to claim 5 wherein the gap also is at least partially bordered by the lower head section on the side of the profile facing towards the rail car.

16. A rail according to claim 15 wherein the gap essentially is U-shaped and comprises a first side essentially extending in parallel to the foot section and a second side and a third side both arranged essentially normal to the first side, said second and third sides at least partially bordered by the lower head section facing away or towards the rail car, respectively.

17. A rail according to claim 1 wherein the upper head section and the lower head section are electrically connected.

18. A rail according to claim 1 comprising a drainage connection between the gap and the outer surface of the rail.

19. A rail according to claim 1 wherein the gap and/or the one or more elastomeric materials comprised by the gap are shaped to allow for a progressive force.

20. A rail according to claim 1 wherein the gap comprises an elastomeric material having an elasticity modulus E of between 100 and 140 MPa.

21. A rail according to claim 1 wherein the gap comprises an elastomeric material having an elasticity modulus E of between 10 and 40 MPa.

22. A rail according to claim 21 wherein the gap comprises at least one elastomeric material having an elasticity modulus E of between 100 and 140 MPa and at least one elastomeric material having an elasticity modulus E of between 10 and 40 MPa.

23. A rail according to claim 1 wherein the one or more elastomeric materials comprised in the gap each exhibit a permanent set of less than 10%.

24. A rail according to claim 1 wherein the gap comprises one or more elastomeric materials selected from a group of materials comprising natural rubber, SIS block copolymers, SBS block copolymers, SEBS block copolymers, elastomeric polyurethanes, elastomeric silicone polymers, elastomeric ethylene copolymers including ethylene/vinyl acetate copolymers, elastomeric ethylene propylene copolymers, ethylene/propylene/diene elastomeric materials, elastomeric epoxy polymers, elastomeric 1K or 2K adhesives including elastomeric acrylate adhesives, elastomeric foams as well as blendes of the foregoing polymers.

25. Method of manufacturing a rail comprising the following steps:
(i) providing a lower portion of the rail comprising a foot portion, a web portion and a lower head section fixedly connected to the web portion,
(ii) providing an upper head section having a geometrical moment of inertia J in a vertical direction and an area A of the profile so that the product A×J^{1/3} is less than 230 cm^{10/3}, and
(iii) providing one or more elastomeric materials and arranging said one or more elastic materials intermediate between the upper and the lower head sections so that the upper and lower head sections are discontiguously separated from each other by a gap extending in the vertical and horizontal direction.

26. Method of manufacturing a rail comprising the following steps:
(i) providing a lower portion of the rail comprising a foot portion, a web portion and a lower head section fixedly connected to the web portion,
(ii) providing an upper head section, and
(iii) providing one or more elastomeric materials and arranging said one or more elastic materials intermediate between the upper and the lower head sections so that the upper and lower head sections are discontiguously separated from each other by a gap extending in the vertical and the horizontal direction whereby the gap has at least a first gap section comprising said one or more elastomeric materials and at least a second gap section which is essentially free of said one or more elastomeric materials and has a width which is small enough so that the upper head section contacts the lower head section in the area of such second gap section when subjecting the rail to horizontal forces exerted by the rail vehicle.
